(19) United States
(12) Patent Application Publication
(10) Pub. No.: US 2009/0094099 A1
(43) Pub. Date: Apr. 9, 2009

(54) EVALUATING COMMODITY CONDITIONS USING MULTIPLE SOURCES OF INFORMATION

(75) Inventor: Charles Linville, Champaign, IL (US)

Correspondence Address: K&L GATES LLP;HENRY W. OLIVER BUILDING, 535 SMITHFIELD STREET, PITTSBURGH, PA, 15222, US

(73) Assignee: Archer-Daniels-Midland Company, Decatur, IL (US)

(21) Appl. No.: 12/248,135

(22) Filed: Oct. 9, 2008

Related U.S. Application Data
(60) Provisional application No. 60/978,554, filed on Oct. 9, 2007.

(51) Int. Cl. G06Q 50/00; G06Q 40/00

(52) U.S. Cl. 705/10; 705/36 R

(57) ABSTRACT

Various tools, strategies and techniques are provided for evaluating the condition of commodities in different regions of interest. The evaluation of commodity condition can be facilitated through using multiple information sources and/or one or more likelihood functions associated with the information sources. One or more probability distribution functions may be generated to provide an indication of commodity condition.

### CROSS REFERENCE TO RELATED APPLICATION/PRIORITY CLAIM

The present application claims the benefit of U.S. Provisional Patent Application Ser. No. 60/978,554, filed on Oct. 9, 2007, the entirety of which is hereby incorporated by reference.

### FIELD OF THE INVENTION

The invention generally relates to evaluating the condition of various commodities. The invention more particularly relates to evaluating or analyzing commodity conditions by combining different sources of information.

### BACKGROUND

For entities that depend on commodities in their commercial endeavors, it is critical to understand the factors that affect the development, procurement and use of commodities. For example, producers and purchasers of grain and other types of growing crops need to track, evaluate and manage factors such as seasonal changes, weather conditions, infestation, and other conditions that may affect the viability and available supplies of such crops. The tools and techniques employed to monitor commodities are generally insufficient, however, for performing effective and efficient evaluations of commodity condition. Typical methods for studying crop condition make use of fairly limited sources of information, and do not necessarily have an integrated, conceptually coherent method of fusing different sources of information fusion.

In view of the foregoing issues, more effective strategies, tools and techniques are needed to improve the ability of commodity producers and commodity purchasers, among others, to evaluate commodity conditions.

### BRIEF DESCRIPTION OF THE FIGURES

The utility of the embodiments of the invention will be readily appreciated and understood from consideration of the following description when viewed in connection with the accompanying drawings, wherein:

FIG. 1 includes a schematic illustrating various potential regions of interest within a geographic area;

FIG. 2 includes a process flow diagram illustrating various exemplary aspects of methods for evaluating commodity condition in accordance with embodiments of the invention;

FIG. 3 includes a system architecture diagram for an example of a geographic information system structured in accordance with various embodiments of the invention; and,

FIG. 4 includes a schematic illustrating various information sources that may be input into the geographic information system of FIG. 3.

### DESCRIPTION

As applied herein, the term “commodity” may include any product or service considered a commodity by those skilled in the art. Examples of commodities suitable for application of embodiments of the invention include, without limitation, grain, corn, soy beans, cotton, wheat, cocoa, grain sorghum, sunflower, plants, and/or other agricultural products. Different types of crops, for example, are used herein to illustrate various embodiments of the invention, but other kinds of commodities may be equivalently applied within the scope of the invention.

The term “condition” as applied to various commodities, or the environments in which the commodities are located, can include, for example and without limitation, various degrees or states of growth, lack of growth, aridity, infestation, contamination, destruction (e.g., as may be caused by fire, floods, or other natural or man-made disasters), rust, readiness for harvest, soil condition, and/or many other conditions of the commodities or the environments in which they are located.

Challenges associated with evaluating agricultural commodity markets include knowing what kinds and quantities of different crops have been planted and estimating what the yield of the crops will be at harvest time. Various embodiments of the invention leverage the use of multiple sources of different information for analyzing information affecting crop conditions across many different geographic regions. The information may be analyzed within one or more types of probabilistic frameworks to enhance its predictive value.

In certain aspects, the embodiments of the invention described herein may fuse or combine a broad set of different sources of information (e.g., soil data, satellite imagery, weather data, ground surveys, historical data about crop production, historical weather data, and others) within a Bayesian analytical framework, for example. The embodiments may involve the assessment of prior distributions of various factors that can lead directly or indirectly to one or more indicators associated with commodity conditions, such as the level of crop production in various geographic regions, for example. In addition, the embodiments may use models (e.g., process-based crop models) or other simulations to compute various factors, and may use one or more techniques akin to Bayesian Monte Carlo simulation, for example, to generate distributions based on observed and/or historical data.

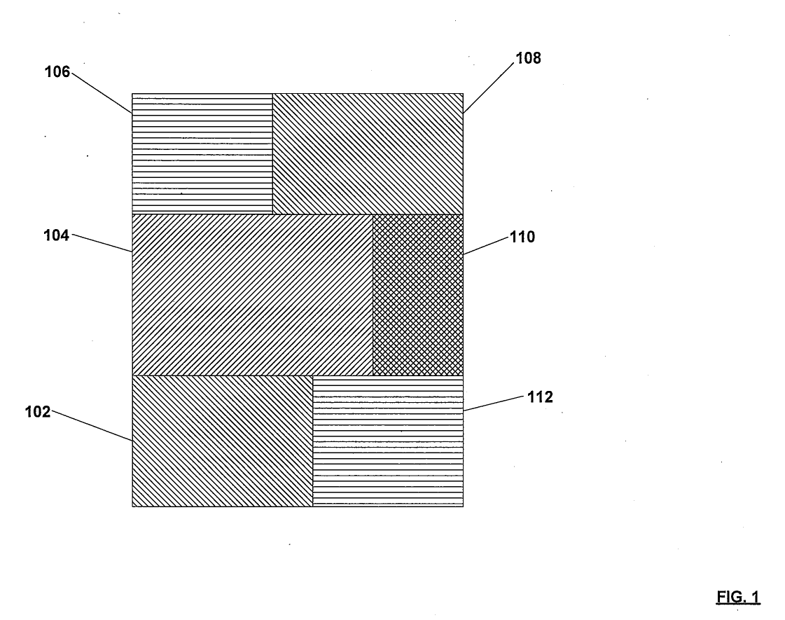

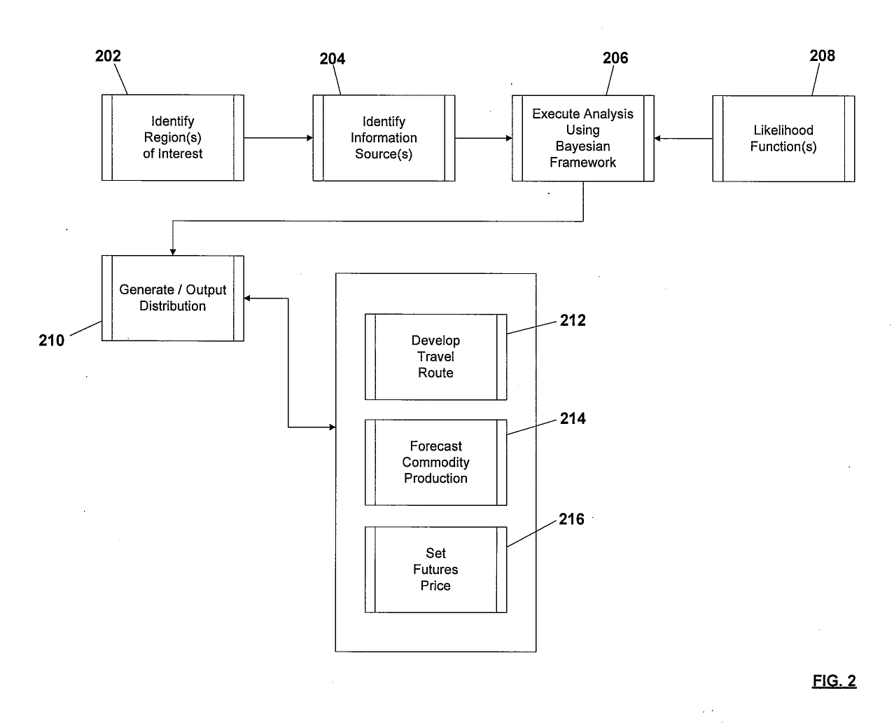

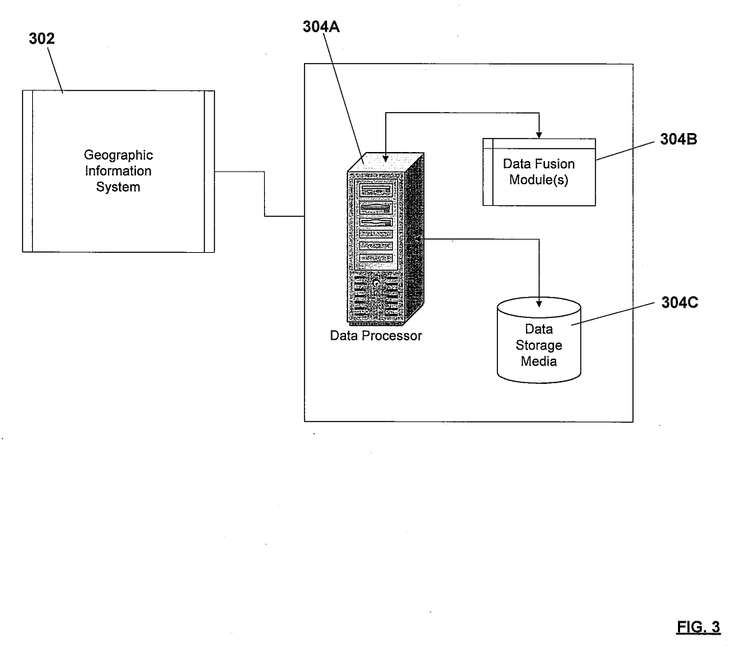

With reference to FIGS. 1 to 4, illustrative examples of a method and system for evaluating the condition of a commodity are provided. At step 202, a region or regions of interest 102-112 that include one or more types of commodities therein can be identified. In general, the region of interests 202-212 can be any geographic location or area from which a commodity or commodities can be grown, produced, or otherwise derived. Such regions of interest may include, for example, areas of land, farms, water, marshes, swamps, mountains, or other natural or manmade areas suitable for locating commodities such as crops.

To illustrate certain aspects of embodiments of the invention, consider that satellite imagery may be employed (e.g., “EarthSat”) to estimate the acreage under cultivation for soybeans in regions of interest 102-112 in the state of Mato Grosso in Brazil, for example. However, the soybean acreage estimates derived solely from satellite image information may be inaccurate, inconsistent, or otherwise ineffective in providing information about the region of interest. The estimates may be improved by considering evidence prior to collection of the satellite images and using that evidence, which may include data or other information obtained from multiple information sources (e.g., ground observations, reports from the USDA (United States Department of Agriculture), reports from local agencies or other commercial information providers, and/or other sources) to assign a prior probability to each of several land cover classes for one or more identified portions (e.g., grid cells) of one or more of the regions of interest 102-112. In various embodiments, one or more likelihood functions expressing the error structure of an information source, such as a satellite-based land cover classification, for example, can be applied to potentially enhance the predictive value of an information source. A likelihood function can be considered a characterization of the quality of the information source or other information gathering mechanism.

In the current example, when the various factors are combined using a Bayes-rule or Bayesian analytical framework, a posterior probability can be calculated and generated for each land cover class for each pixel of the regions of interest 102-112. For example, the factors can be combined to form a probability distribution for the number of acres covered with soybeans. As described below, similar Bayesian techniques may be used to integrate, fuse or combine a plurality of information sources to forecast other commodity quantities or characteristics, such as yield or total production, for example. Bayesian Monte Carlo analysis, for example, is an example of an analytical tool that can be used to integrate a variety of different kinds of evidence and generate a posterior distribution capturing both prior information about commodities of interest and new information uncovered for the commodities. Since the likelihood functions of the various information sources may have a variety of different functional forms, it is beneficial to have a flexible way to combine the different information sources.

For example, suppose that a particular area in one of the regions of interest 202-212 in Brazil is not as green as expected with respect to satellite images of soybean production at a certain time of year. There may be multiple possible explanations for this result. One possible explanation is that the soybeans in that area are affected by insufficient leaf area and therefore not as much green light is reflected toward the satellite-based measurement device. Another possible explanation is measurement error arising from the satellite-based device, which may be further complicated by frequent cloud cover in the area, for example. Another possible explanation is that the land containing the area has been converted from use for production of soybeans to another use that perhaps does not have comparatively as green of a profile. Applying a Bayesian analytical framework to this situation allows the combination of various information sources to reason through the possible explanations in an automated or computer-assisted manner. The framework may be designed and executed in the form of a computer-assisted algorithm that accounts for the likelihood that each of the different explanations is plausible. In operation, the algorithm may be configured to output or generate an indication in the form of a distribution of the amount of soy beans that will be produced in the area in the current crop year, for example. It can be seen that the output distribution can be based, at least in part, on prior distribution information associated with historical soybean yield in the area or region of interest.

In various embodiments described herein, it can be seen that the Bayesian framework and other probabilistic approaches may offer a way to combine information sources, likelihood functions associated with the information sources, and newly observed or gathered data associated with commodity conditions. These frameworks and approaches may produce logically consistent and coherent posterior distributions that consider historical information, newly observed information, and/or characterizations of the quality of the historical data or newly observed data.

At step 202, one or more regions of interest 102-112 may be identified for analysis by a geographic information system 302 (sometimes referred to herein as “GIS”) structured in accordance with various embodiments of the invention. The geographic information system 302 may be used as a tool for combining or fusing a variety of information sources 402A-402I, one or more of which can be identified or selected at step 204. In certain embodiments, the geographic information system 302 may be embodied as a GIS package including graphical user interfaces, for example, that allow a user to work with different information sources and perform a variety of data processing steps. One example of a geographic information system that may be suitable for application in association with embodiments of the invention is the “Arkview” GIS offered under the “ESRI” trade designation (www.esri.com).

In various embodiments, the geographic information system 302 may include a data processor 302A operatively associated with one or more data fusion modules 302B and/or one or more data storage media 302C. The data fusion modules 302B may be configured or programmed for executing a variety of instructions associated with fusion or combination of the different information sources 402A-402I in association with assessment of commodity conditions such as crop conditions. For example, one or more of the data fusion modules 302B may be programmed to conduct Bayesian-type Monte Carlo simulations that produce one or more distributions or probability distributions indicative of commodity condition as a function of various observed and historical commodity data. In certain embodiments, the data fusion modules 302B may be configured to process one or more likelihood functions associated with the various information sources 402A-402I. The data storage media 302C may be configured to receive, store or communicate various data associated with commodity condition processing performed by the geographic information system 302.

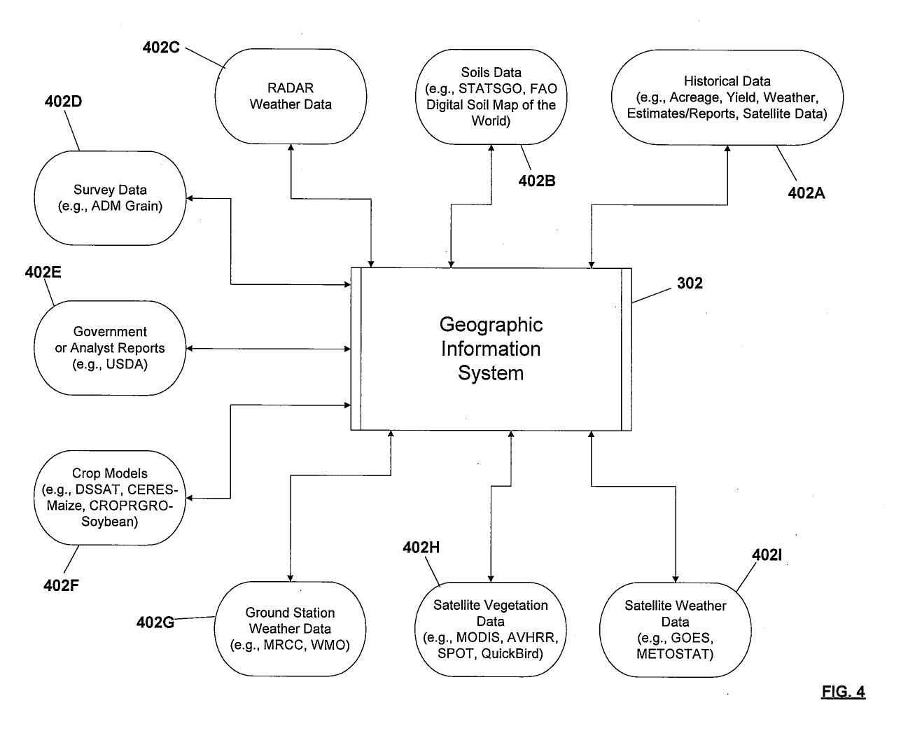

As shown in FIG. 4, the information sources 402A-402I may include one or more different types of sources of data or other information related to commodity conditions. One information source illustrated is a historical data information source 402A, which includes data associated with past events or conditions, such as acreage, yield, weather, estimates or reports, and/or satellite data. A soils data information source 402B may provide soil information derived from various sources such as STATSGO, FAO (Food and Agricultural Organization of the United Nations), and/or digital soil maps of global or regional areas. A radar weather data information source 402C may provide radar weather information for one or more regions or areas. Another information source is survey data 402D, such as may be obtained from the “ADM Grain” system maintained and operated by Archer-Daniels-Midland Company (Decatur, Ill.), for example. Government or analyst reports 402E may serve as another information source that can be accessed by the geographic information system 302. One or more crop models 402F including, for example and without limitation, DSSAT, CERES-Maize, CROPRGRO-Soybean, and/or other models or simulations may be employed as information sources. Ground station weather data 402G such as may be provided by MRCC (Midwestern Regional Climate Center) or WMO (World Meteorological Organization), for example, may be used as another information source. For example, MRCC may execute corn and soybean models and publish the results using weather data collected across the Midwest region of the United States. Another potential information source is satellite vegetation data 402H such as may be provided by MODIS, AVHRR, SPOT, or QuickBird, for example. In various embodiments, satellite weather data 402I (e.g., GOES, METOSTAT, etc.) may be used as an information source to obtain data associated with cloud cover, precipitation, and/or temperature, for example.

At step 206, the geographic information system 302 can execute one or more sets of instructions using a Bayesian analytical framework that takes into account one or more of the information sources 402A-402I identified at step 204. As described above, the geographic information system 302 may use one or more of its fusion modules 302B to combine a plurality of the information sources 402A-402I. The geographic information system 302 may then generate or output an a estimate of a probability distribution or other distribution at step 210 that characterizes a state of knowledge, such as commodity condition, for example, for a given commodity in the identified regions of interest 102-112.

At step 212, a travel route can be developed in association with tasking an aircraft to travel over the regions of interest 102-112 to collect data associated with various commodities therein. In various embodiments, development and execution of the travel route may involve using data or information from a variety of sources to perform an assessment of commodity condition and an understanding of the level of uncertainty of what is known about the commodity condition. The assessment may be employed for planning data acquisition activity, such as image data acquisition and collection, for one or more commodities within the various regions of interest 102-112. In various embodiments, development or execution of the travel route for an aircraft may be performed in accordance with the teachings of the commonly owned, co-pending patent application entitled, “Evaluating Commodity Conditions Using Aerial Image Data” to Charles Linville, which is incorporated herein by reference in its entirety.

At step 214, one or more generated distributions data may be used to facilitate forecasting commodity or crop production in a specified geographic region or one or more portions of the regions of interest 102-112. This may include forecasting overall production of a particular crop or commodity for a selected geographical region. The forecasted commodity production information may be provided to one or more customers, such as crop producers, crop sellers, crop buyers, crop brokers, crop distributors, elevator operators, commodities brokers, futures buyers, futures sellers, futures brokers, and/or a variety of other customers. At step 216, the method may include setting a futures price for a specified crop or commodity based at least in part on the forecasted production information.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, wireless phone, smart phone, cable box, pager, processor, including wireless and/or wireline varieties thereof, and/or any other computerized device capable of configuration for receiving, storing and/or processing data for standalone application and/or over a networked medium or media.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, DVD, compact disc, memory stick, ROM (read only memory), RAM (random access memory), PROM (programmable ROM), EEPROM (extended erasable PROM), and/or other like computer-readable media. Where applicable, method steps described herein may be embodied or executed as instructions stored on a computer-readable medium or media.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

The examples presented herein are intended to illustrate potential and specific implementations of the present invention. It can be appreciated that the examples are intended primarily for purposes of illustration of the invention for those skilled in the art. The diagrams depicted herein are provided by way of example. There may be variations to these diagrams or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described herein.

What is claimed is:

1. A method for evaluating the condition of a commodity, the method comprising:
identifying one or more regions of interest, at least one of the regions of interest including at least one commodity;
identifying a plurality of information sources, wherein at least one of the information sources includes data associated with the commodity and at least one of the information sources includes a likelihood function;
combining the plurality of information sources within a Bayesian analytical framework using a geographic information system; and,
generating at least one distribution based on combining the plurality of information sources, the distribution being indicative of at least one condition of the commodity.

2. The method of claim 1, further comprising combining the plurality of information sources within a Bayesian analytical framework and using a Bayesian Monte Carlo simulation to generate the distribution indicative of the condition of the commodity.

3. The method of claim 1, further comprising assigning a prior probability to each of several land cover classes for one or more identified portions of one or more of the regions of interest.

4. The method of claim 1, further comprising applying a likelihood function expressing the error structure of at least one of the plurality of information sources.

5. The method of claim 1, further comprising forecasting a commodity yield based on the generated distribution.

6. The method of claim 1, further comprising developing a travel route for an aircraft based at least in part on the generated distribution.

7. The method of claim 1, further comprising setting a futures price for the commodity based on forecasted production information based at least in part on the generated distribution.

8. The method of claim 1, wherein the plurality of information sources includes at least one information source selected from the group consisting of soil data, satellite imagery, weather data, ground surveys, historical crop production data, and historical weather data.

9. The method of claim 1, wherein the regions of interest includes at least one region of interest selected from the group consisting of area of land, farm, water, marsh, swamp, mountain, manmade area, and crop-producing area.

10. A computer-implemented system for evaluating the condition of a commodity, the system comprising:
a geographic information system programmed for:
identifying one or more regions of interest, at least one of the regions of interest including at least one commodity;
identifying a plurality of information sources, wherein at least one of the information sources includes data associated with the commodity and at least one of the information sources includes a likelihood function; and,
a data fusion module programmed for:
combining the plurality of information sources within a Bayesian analytical framework using a geographic identification system; and,
generating at least one distribution based on combining the plurality of information sources, the distribution being indicative of at least one condition of the commodity.

11. The system of claim 10, further comprising the data fusion module being programmed for combining the plurality of information sources within a Bayesian analytical framework and for using a Bayesian Monte Carlo simulation to generate the distribution indicative of the condition of the commodity.

12. The system of claim 10, further comprising the data fusion module being programmed for assigning a prior probability to each of several land cover classes for one or more identified portions of one or more of the regions of interest.

13. The system of claim 10, further comprising the data fusion module being programmed for applying a likelihood function expressing the error structure of at least one of the plurality of information sources.

14. The system of claim 10, further comprising a module programmed for forecasting a commodity yield based on the generated distribution.

15. The system of claim 10, further comprising a module programmed for developing a travel route for an aircraft based at least in part on the generated distribution.

16. The system of claim 10, further comprising a module programmed for setting a futures price for the commodity based on forecasted production information based at least in part on the generated distribution.
